(19) United States
(12) Patent Application Publication
(10) Pub. No.: US 2010/0165406 A1
(43) Pub. Date: Jul. 1, 2010

(54) Split Large Image Printing

(75) Inventor: Alimin Purnomo, Fremont, CA (US)

Correspondence Address: BUCHANAN, INGERSOLL & ROONEY PC, POST OFFICE BOX 1404, ALEXANDRIA, VA, 22313-1404, US

(73) Assignee: Konica Minolta Systems Laboratory, Inc., Huntington Beach, CA (US)

(21) Appl. No.: 12/347,701

(22) Filed: Dec. 31, 2008

(51) Int. Cl. G06K 15/00

(52) U.S. Cl. 358/1.18

(57) ABSTRACT

A printing system, which includes a printer and a client computer having executable instructions for creating a print job. The executable instructions include selecting a medium; dividing an image into a plurality of image partitions; determining margins for the image on the image partitions based on a selected composition layout of the image partitions; and locating the image within the plurality of image partitions in accordance with the determined margins. The printer and the client computer are connected via a network.

### FIELD OF THE INVENTION

This invention relates to printing of large format printouts (poster printing), and in particular, it relates to a network printing system and method of creating a print job for producing a large format printout of an image, which is centered and/or located within a plurality of image partitions based on a selected composition layout.

### BACKGROUND OF THE INVENTION

Poster printing refers to large format printing where the printouts have sizes many times larger than a letter or A4 sized sheet. For example, a poster may be 36 inches by 24 inches in size. In addition, high quality printouts are desired for poster printing. Conventionally, posters are printed on large format papers and require sophisticated, large printers to print. Small printers, i.e., printers typically used in homes or business offices, are typically limited to letter, legal, A4 and A3 sizes papers and cannot handle larger sized papers.

To enable printing of a large format poster using a small printer in an inexpensive manner, some printer drivers or application software provide a poster printing function, which divides the large poster image into smaller image sections, typically rectangular in shape. For example, a 24 inch by 36 inch poster is divided into 2 by 3 image sections or partitions to be printed. The image sections or partitions are printed separately on individual sheets of paper, and assembled together by the user to form a large format poster.

In addition, the images on the large format printing or poster printouts are often positioned in the upper left hand corner or towards one edge of the assembled large format poster, which provides little or no margin surrounding the image and/or images.

### OBJECTS AND SUMMARY

It would be desirable to create a print job of a large image on a client computer, wherein the print job divides the image into a plurality of sheets (or pages), and when assembled, the image is centered relative to the number of sheets that are used and having a margin and/or border of approximately equal distance and/or a desired distance around the image.

In accordance with an exemplary embodiment, a printing system, comprising: a printer; a client computer having executable instructions for creating a print job for producing a printout of an image, comprises: selecting a medium; dividing the image into a plurality of image partitions; determining margins for the image on the image partitions based on a selected composition layout of the image partitions; and locating the image within the plurality of image partitions in accordance with the determined margins; and wherein the printer and the client computer are connected.

In accordance with another exemplary embodiment, a method for producing a print job for a large printout on a client computer, comprises: selecting a medium; dividing an image into a plurality of image partitions; determining margins for the image on the image partitions based on a selected composition layout of the image partitions; and locating the image within the plurality of image partitions in accordance with the determined margins.

In accordance with a further exemplary embodiment, a computer readable medium containing a computer program for creating a print job, wherein the computer program comprises executable instructions for: selecting a medium; dividing an image into a plurality of image partitions; determining margins for the image on the image partitions based on a selected composition layout of the image partitions; and locating the image within the plurality of image partitions in accordance with the determined margins.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram of a network printing system for creating a print job for printing a large format printout of an image in accordance with an exemplary embodiment;

FIG. 2 is an illustration of a driver user interface associated with a client computer in accordance with an exemplary embodiment;

FIG. 3A is an illustration of a 2×3 partition on a preview bitmap of a user interface in accordance with an exemplary embodiment;

FIG. 3B is an illustration of a 3×2 partition on a preview bitmap of a user interface in accordance with an exemplary embodiment;

FIG. 4 is an illustration of a 3×3 partition on a preview bitmap of a user interface in accordance with another exemplary embodiment;

FIG. 5 is a flow chart illustrating a method for producing a print job for an image in accordance with an exemplary embodiment; and

FIG. 6 is a flow chart illustrating a computer readable medium containing a computer program for producing a print job for an image in accordance with another exemplary embodiment;

FIG. 7 is an illustration of a 2×3 partition on a preview bitmap of a user interface in accordance with another exemplary embodiment; and

FIG. 8 is an illustration of a raster line form of assembly for referencing indexing printing, wherein P indicates a partition, and an arrow line indicates raster line like formatting.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, an improved poster printing method according to embodiments of the present invention for creating a print job for splitting banners and/or large image printing (i.e., poster printing) into multiple sheets of a supported paper size without enlarging and/or resizing the image is disclosed. It can be appreciated that by not enlarging and/or resizing the image, the resolution of the image is not changed. In accordance with an exemplary embodiment, the method includes selecting a medium, dividing the image into a plurality of image partitions, determining margins for the image on the image partitions based on a selected composition layout of the image partitions, and locating the image within the plurality of image partitions in accordance with the determined margins. In accordance with an exemplary embodiment, the image is centered within the plurality of image partitions. In accordance with another exemplary embodiment, the image is divided into a plurality of image partitions having a smallest number of sheets of the selected medium.

It can be appreciated that large image printing includes in most cases images having a size equal to or greater than a defined paper and/or medium size, and wherein at least one or more sheets of paper and/or medium are needed. However, it can be appreciated that in accordance with an exemplary embodiment, the image can be equal to or less than the defined paper and/or medium size, and the user may wish to print the image on one or more sheets of paper and/or medium.

In addition, it can be appreciated that in accordance with an exemplary embodiment, the method provides the ability to print large images onto smaller supported paper size, wherein there is no resizing of the image (i.e., the image is not enlarged and/or shrunk to reduce or expand resolution of the original image), which preserves the resolution of the image. In accordance with an exemplary embodiment, the image can be reconstructed in the center of the plurality of sheets of paper and/or medium, such that the outer edge or border of the large image has a border having equal distance space on the left side and right side, and an upper portion (top portion) and a bottom portion, respectively.

In accordance with another exemplary embodiment, the method as described herein constructs the image by splitting the image into a plurality of image partitions of a known paper size and into the smallest number of image partitions required to print the document in full image. It can be appreciated that in accordance with an exemplary embodiment, upon the selection of a paper size (or a medium size), the system calculates whether the image should printed in a landscape orientation or a portrait constructed image to achieve a smaller required number of sheets of paper.

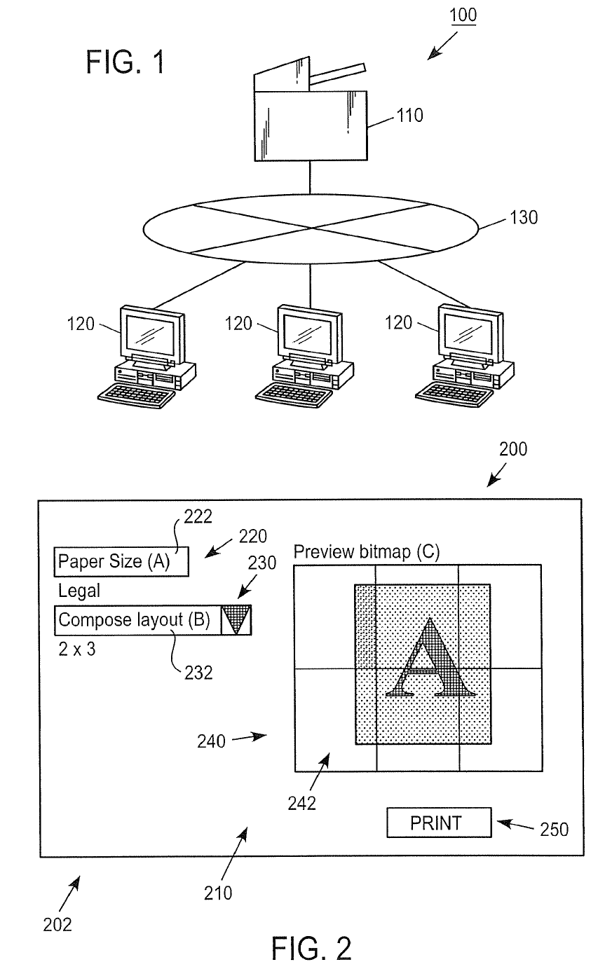

FIG. 1 is a diagram of a network printing system 100 for printing a large format printout of an image in accordance with an exemplary embodiment. As shown in FIG. 1, the system includes a printer 110 and a client computer 120, which are connected to each other via a network 130 (e.g., LAN or WAN). In accordance with an exemplary embodiment, the client computer 120 includes executable instructions for creating a print job for producing a printout of a large image divided into a plurality of pages or image partitions. The printer 1 10 receives the print job from the client computer 120 and interprets the print job to develop printable bitmap images of the pages, which are then printed.

Examples of the network 130 consistent with embodiments of the invention include, but are not limited to, an internet, an intranet, a local area network (LAN) and a wide area network (WAN). The printer 110 and the client computer 120 can be connected with a wire or be connected with wireless by using radio frequency (RF) and/or infrared (IR) transmission.

In accordance with an exemplary embodiment, the client computer 120 includes an operating system software (OS), an application software and a printer driver software. The printer driver software controls the printer 110 connected with the client computer 120 in which the printer driver software is installed. In certain embodiments, the printer driver software produces a print job based on an image and/or document data. In certain embodiments, the printer driver software can control transmission of the print job from the client computer 120 to the printer 1 10.

In accordance with an exemplary embodiment, the client computer 120 produces the print job based on the image and/or the document data and sends the print job to the printer 1 10. Users of the client computer 120 can produce the image and/or create the print job, which is sent to the printer via the network 130. Examples of the client computer 120 consistent with certain embodiments of the invention include, but are not limited to, a PC and a personal digital assistance (PDA). The client computer 120 preferably includes a processing unit, a storing unit, a display unit, an input unit and a transmit unit.

It can be appreciated that in accordance with an exemplary embodiment, the processing unit of the client computer 120 controls the entire client computer and/or the various units in the client computer. The processing unit can run various software including the OS, the application software and the printer driver software. In accordance with an exemplary embodiment, the processing unit produces a print job based on the image and/or document data using the printer driver software. Examples of the processing unit consistent with certain embodiments of the invention include, but are not limited to, a central processing unit (CPU) or a micro processing unit (MPU) with a memory and a software necessary for the processing.

Examples of printers 110 consistent with exemplary embodiments of the invention include, but are not limited to, a laser beam printer (LBP), a multi function laser beam printer including copy function (MFP), an ink jet printer (IJP), a thermal printer (e.g., a dye sublimation printer) and a silver halide printer. The printer can be a color printer or a black and white (B/W) printer. In accordance with an exemplary embodiment, the printer 110 includes a processing unit, a print unit, and a transmit unit.

FIG. 2 is an illustration of a driver user interface 200 associated with a client computer 202 in accordance with an exemplary embodiment. As shown in FIG. 2, the driver user interface 200 includes a graphical user interface screen 210 having a paper size window 220, a compose layout window 230, a display (or display window) 240 in the form of a preview bitmap 242, and a print button 250. In accordance with an exemplary embodiment, the paper size window 220, the compose layout window (or composition layout window) 230 and the print button 250 are preferably controlled through the use of cursor via a mouse and/or keyboard. In accordance with an alternative embodiment, the paper size window 220, the compose layout window (or composition layout window) 230 and the print button 250 can be controlled via touch screen technology, which can detect the presence and location of a touch within the display area to change the paper size, change the layout of the image, and to initiate and/or start the printing process.

In accordance with an exemplary embodiment, the driver user interface 210 displays at least one paper size option 222 within the paper size window 220, a compose layout (or composition layout) 232 in form of matrix, which indicates how the image partitions will print according to the size of the selected medium (or paper) and as displayed in the preview bitmap 242. In accordance with an exemplary embodiment, the preview bitmap 242 displays a plurality of rectangular partitions, which illustrate how the large print image is partitioned upon a selection of a particular paper size. For example, as shown in FIG. 2, if the paper size (or medium) 222 chosen is Legal size, the compose layout 232 would be a 2×3 matrix. Alternatively, if a smaller size sheet of paper (or medium) 222 is selected the compose layout 232 can have a different matrix, such as a 3×3 matrix.

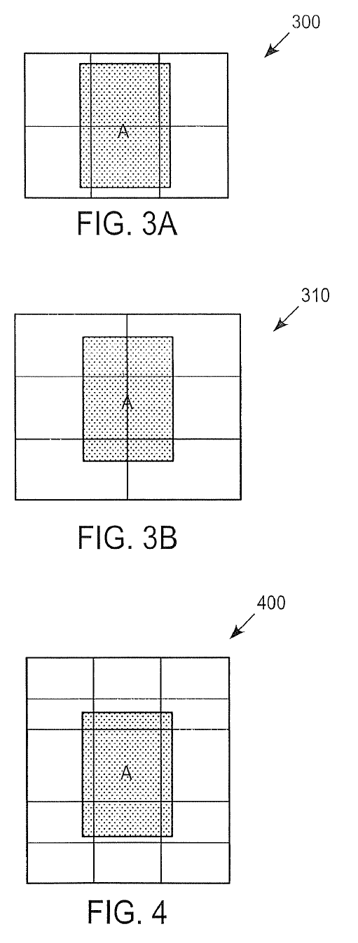

In accordance with an exemplary embodiment, it can be appreciated that the selection of the sheet size 222 and the compose layout 232 does not affect the orientation of the partitioning when the final output is printed. For example, as shown in FIG. 3A, when a 2×3 compose layout 232 is selected, the image has a portrait orientation 300, while as shown in FIG. 3B, when a 3×2 compose layout 232 is selected, the image has a landscape orientation 310. In accordance with an exemplary embodiment, the system is configured to print the document image with a given set of parameters without the need to reorient the document image, and the image (or document image) will print exactly as represented in the preview bitmap 242.

In accordance with an exemplary embodiment, the compose layout window 230 has a set of layouts 232 (or matrixes, such as 1×1, 1×2, 1×3, 2×1, 2×2, 2×3, 3×1, 3×2, and 3×3) using a roll down cursor window. It can be appreciated that the compose layout 232 is dependent on the paper size 222 chosen and the size of the document image as provided. It can be appreciated that the compose layout 232 is preferably set or based on the paper size 222 selected, however, in accordance with an alternative embodiment, a compose layout 232 can be selected, which then will dictate the paper size. In accordance with an exemplary embodiment, a default value can be set, wherein the system automatically selects a paper size based on a best fit, a preferred paper size and/or a combination thereof. For example, the compose layout 232 can be chosen based on the smallest or fewest sheets of paper 222 of a selected size. It can be appreciated that in accordance with an exemplary embodiment, the system can have a default setting, wherein when a document image is smaller than a chosen paper size, the system will set the compose layout 232 to a value that is 1×1.

In accordance with an exemplary embodiment, given a compose layout (or compose value) 232, the image can also have a reverse compose layout (or compose value) as well. It can be appreciated that although the reverse compose layout 232 will not be less than the required sheets of paper needed, that is if 2×3 partition (or matrix) 300 as shown in FIG. 3A is chosen, there will be a 3×2 partition (or matrix) available in the set. Alternatively, when a value (i.e., column or row) has an even number (i.e., 2, 4, 6, etc.) of column or rows in a partition (or a matrix), for example 2×3, in some circumstances, the overall appearance of the printout can be improved by adding an additional partition into the compose layout 400 such as 3×3 as illustrated by the addition of the partitions in FIG. 4.

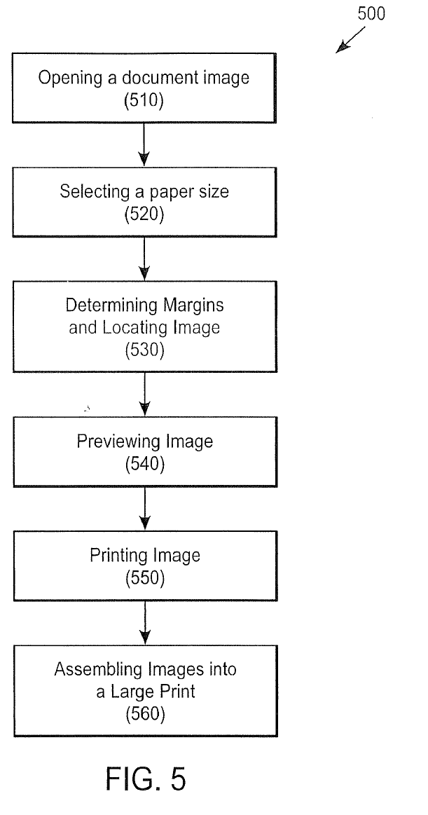

As shown in FIG. 5, a method of creating a print job on a client computer for a large format printout of an image 500 is disclosed. Initially, a document image is opened on a system application (Step 5 10). In accordance with an exemplary embodiment, the system application is implemented by a software program as a part of the printer driver or a part of an application program that handles images. A paper size is selected within the printer driver user interface (Step 520). The next step is determining margins for the image on the image partitions based on a selected composition layout of the image partitions and locating the image within the plurality of image partitions in accordance with the determined margins (Step 530). In accordance with an exemplary embodiment, it can be appreciated that the image can be located or centered within the plurality of image partitions based on a best fit, which is calculated based on the smallest (or fewest) number of sheets of the selected medium needed to locate or center the image as desired. It can be appreciated that if a margin is needed on each sheet of the medium to transport the medium through the printing unit, the software program will account for the necessary margins during the calculation of the number of sheets of the selected medium and the matrix thereof.

A preview of the image partitions can then be generated and displayed in a display window or preview bitmap (Step 540). If the image is arranged within plurality of image partitions as desired, the user sends a signal to the printer in the form of a print job, which is interpreted by the printer. The printer develops a printable bitmap image of the plurality of image partitions (or pages) and prints the plurality of image partitions (Step 550). The plurality of image partitions (or pages) is then assembled into a poster or large image format printout (Step 560).

It can be appreciated that in accordance with an exemplary embodiment, a default value on a compose layout (or matrix) is preferably set to a given paper size or best fit. If the plurality of image partitions does not meet the user's desired appearance, the user can select a different compose value by changing the paper size and/or implementing a different matrix into the compose window.

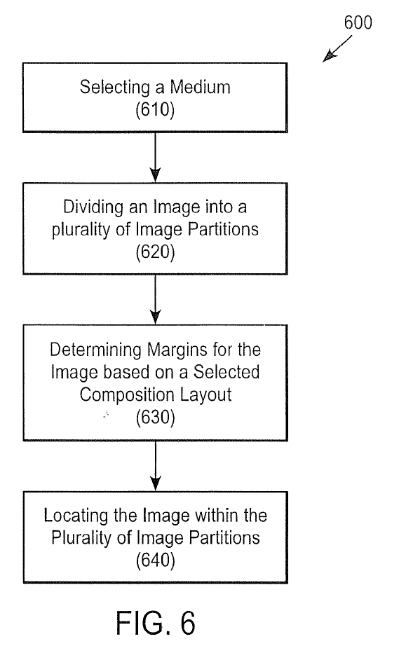

In accordance with another exemplary embodiment, a computer readable medium 600 containing a computer program for creating a print job for a large format printout of an image is disclosed. As shown in FIG. 6, the computer program comprises executable instructions for: selecting a medium (Step 610); dividing the image into a plurality of image partitions having a smallest number of sheets of the medium (Step 620); determining margins for the image on the image partitions based on a selected composition layout of the image partitions (Step 630); and locating the image within the plurality of image partitions in accordance with the determined margins (Step 640).

In accordance with an exemplary embodiment, when the system receives a command to create a print job for an image and/or print of a large format printout, the software (or software program) obtains the size of the image and calculates the required sheets of paper needed for a particular paper size. The system and/or method will preferably obtain a best fit by determining the overall height and width of the image and the number of sheets of the selected medium or paper needed. The number of sheets of the selected medium or paper is then used to generate at least one matrix, which will fit the image. The overall size of the large format printout or poster will be determined by multiplying the height and width of each sheet by the number of sheets in each row and column.

Once the matrix has been selected and an overall height and width of the printout has been obtained, the image can be centered within the image partitions by subtracting the height and width of the image from the overall height and width of the printout (i.e., selected matrix). The difference between the height and width of the printout and the image provides an available margin for the top and bottom portions, and the right and left edges, respectively. The available margins (i.e., top and bottom margin, and right and left edge margin) are then divided by two to position the image within the center of the plurality of image partitions. It can be appreciated that in accordance with another embodiment, the user can manually adjust the margins to a desired setting, such that the margin on the top and/or bottom, alternatively, the right or left edge are not equal to one another.

It can be appreciated that methods may be implemented by software as a part of a printer driver or a part of an application program that handles images. The invention is directed to both the method and an apparatus, such as a printer or computer, which implements the method by executing a program stored in a non-volatile memory, such as a read only memory (ROM). The method may be introduced into the apparatus by updating the firmware in the non-volatile memory. In this regard, the method may be brought to the apparatus in a form of a package of install software and the firmware, which may be divided and/or compressed so that the install software effectively installs the firmware. The package may be steadily stored in a computer readable diskette, such as a compact disk, or may be transmitted through a wire/wireless communication line.

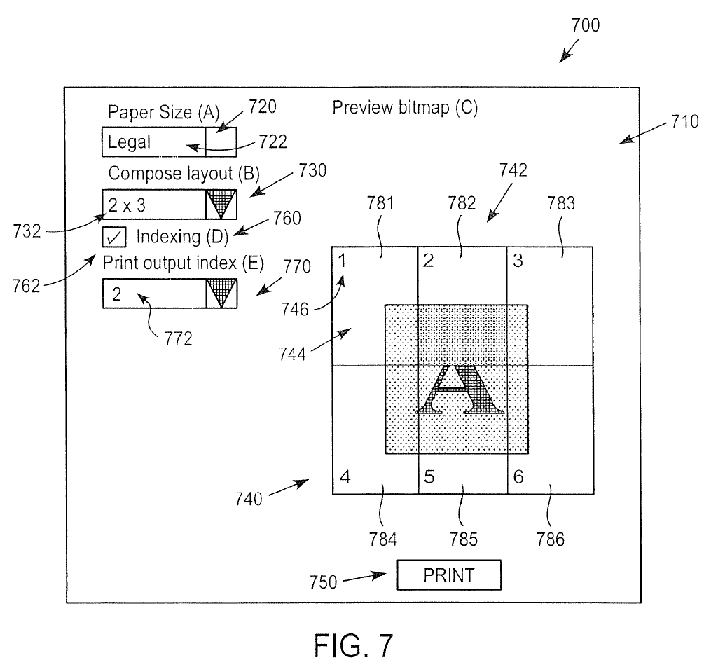

Additional features may be provided in the poster printing function of the printer driver or application program. For example, the software may allow the user to selectively print individual sheets of a poster (or index printing) as shown in FIG. 7. It can be appreciated that index printing can be convenient for the user, because in the printing and assembling process of a poster, sometimes one or more individual sheets may be destroyed due to user error. It would be wasteful to re-print each of the sheets of the entire poster. Thus, the software provides user an option to print only the sheets that contain selected images. A driver user interface such as a poster print preview or bitmap can allow the user to easily select the image sections or sheets to be re-printed.

In accordance with an exemplary embodiment, the system and methods as described herein include index printing, which provides the user the ability to selectively print individual sheets of the image (or poster). As shown in FIG. 7, the driver user interface 700 includes a graphical user interface screen 710 having a paper size window 720, a compose layout window 730, a display (or display window) 740 in the form of a preview bitmap 742, a print button 750, an indexing window 760, and a print output index window 770. The indexing window 760 includes a check box 762, which controls the on/off function of the index printing. In accordance with an exemplary embodiment, the print output index window 770 includes a numeric script number (and/or symbol) 772, which corresponds to a numeric script number 746 on each of the partitions 744 of the bitmap 742, and which is based on the layout matrix chosen in the compose layout window 730. It can be appreciated that the numeric script number (and/or symbol) 772 can be a numeric number, alphabetic letters, a combination thereof, or any other system in which the corresponding partitions 744 on the bitmap 742 can be identified.

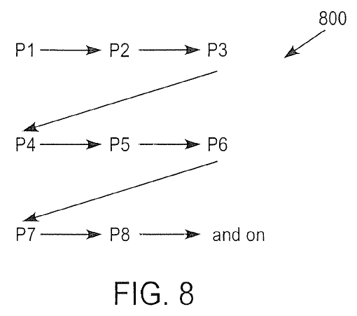

In accordance with an exemplary embodiment, a method of index printing includes when the user which to select indexing, the user checks the check box 762 on the preview bitmap 742, which displays the partitions with their corresponding numeric script number 746 on the upper corner of each partition 744, or alternatively, the corresponding numeric script number 746 can be displayed on any location that does not interfere with the bitmap view. It can be appreciated that the corresponding numeric script number 746 will be based on the compose layout matrix, and which is associated with the matrix value. In accordance with an exemplary embodiment, the corresponding numeric script number 746 can be a raster line 800 form of assembly, wherein P indicates a partition, and an arrow and line indicates raster line like formatting. As shown in FIG. 8, the raster line 800 starts from the upper left corner to the right, then down and starting from left to right again. The numeric script numbers 746 continue until each of the partitions 744 is assigned a numeric script number 746. Alternatively, if the indexing window is unchecked (i.e., no indexing), the system will not display numeric script numbers 746 in the preview bitmap 742. In accordance with an exemplary embodiment, the check box 762 is checked by default

In accordance with an exemplary embodiment, the print output index window 770 provides the user the ability to select the numeric script number 746 associated with the image shown in preview bitmap 742, such that the system will only print the selected output image identified by the index 772. In accordance with an exemplary embodiment, the partition 744 selected will print exactly as one shown in partition selection on preview bitmap 742.

It can be appreciated that in accordance with another exemplary embodiment, the print indexing does not interfere with print options of the system, since when the print output index 772 has value other than none or zero (0), then output will refer to index printing, if the value is none or zero than the system will print the entire image (i.e., split large image printing). It can be appreciated that the print output index window 770 preferably has a set of value constraints based on the chosen compose layout 732 (and/or paper size 722). For example, in the case as shown in FIG. 7 having a compose layout of 2×3, the value of the print output index set can consist of numeric script numbers 772 from none or zero to 6, wherein the numeric script numbers 746 are as follows: none or zero, corresponds to split large image printing; 1 corresponds to 1×1 (781); 2 corresponds to 1×2 (782); 3 corresponds to 1×3 (783); 4 corresponds to 2×1 (784); 5 corresponds to 2×2 (785); and 6 corresponds to 2×3 (786).

In accordance with another exemplary embodiment as shown, a positioning index is printed on each sheet to assist in the assembling process. Sometimes it may be difficult for the user to determine which printed sheet should be placed at which position when assembling the poster. In accordance with an exemplary embodiment, a small positioning index, such as a pair of column and row numbers, may be printed in the overprinted area of each sheet, such as near a corner, to help the user identify the sheet during assembly. The position index should be printed in an area that will either be torn off or in an area that will be covered by a neighboring sheet.

The method described above can be used to print on paper or other suitable printing medium such as thin plastic sheets, etc. The computer readable medium, of course, may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if embodiment of the present invention is combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A printing system, comprising:
a printer;
a client computer having executable instructions for creating a print job for producing a printout of an image, comprising:
selecting a medium;
dividing the image into a plurality of image partitions;
determining margins for the image on the image partitions based on a selected composition layout of the image partitions; and
locating the image within the plurality of image partitions in accordance with the determined margins; and
wherein the printer and the client computer are connected.

2. The system of claim 1, wherein the printer receives the print job from the client computer and develops printable bitmap images of the plurality of image partitions in accordance with the determined margins.

3. The system of claim 2, wherein the printer prints the bitmap images of the plurality of image partitions in accordance with the determined margins.

4. The system of claim 1, wherein locating the image within plurality of image partitions provides a border of equal distance on an upper portion and a bottom portion of the image, and a border of equal distance on a left side and a right side of the image.

5. The system of claim 1, wherein the client computer has a display which displays the image and a sheet size of the medium.

6. A method for producing a print job for a large printout on a client computer, comprising:
selecting a medium;
dividing an image into a plurality of image partitions;
determining margins for the image on the image partitions based on a selected composition layout of the image partitions; and
locating the image within the plurality of image partitions in accordance with the determined margins.

7. The method of claim 6, further comprising previewing the image in a display associated with the client computer.

8. The method of claim 6, further comprising:
choosing a different sheet size; and
redividing the image into a plurality of image partitions.

9. The method of claim 6, further comprising sending the print job to a printer.

10. The method of claim 9, wherein the printer receives the print job and interprets the print job to develop printable bitmap images of each of the plurality of image partitions on a sheet of the selected medium.

11. The method of claim 10, further comprising printing each of the plurality of image partitions on a sheet of the selected medium.

12. The method of claim 11, further comprising printing a positioning index on each sheet of the medium.

13. The method of claim 6, further comprising selecting a sheet size of the medium and an orientation of the image within the plurality of image partitions.

14. The method of claim 6, further comprising selecting a composed layout matrix based on a sheet size of the medium.

15. The method of claim 6, wherein locating the image within the plurality of image partitions provides a border of equal distance on an upper portion and a bottom portion of the image, and a border of equal distance on a left side and a right side of the image.

16. A computer readable medium containing a computer program for creating a print job, wherein the computer program comprises executable instructions for:
selecting a medium;
dividing an image into a plurality of image partitions;
determining margins for the image on the image partitions based on a selected composition layout of the image partitions; and
locating the image within the plurality of image partitions in accordance with the determined margins.

17. The computer readable medium of claim 16, further comprising previewing the image in a display on a client computer.

18. The computer readable medium of claim 16, wherein locating the image with plurality of image partitions provides a border of equal distance on an upper portion and a bottom portion of the image, and a border of equal distance on a left side and a right side of the image.

19. The computer readable medium of claim 16, further comprising:
choosing a different sheet size; and
redividing the image into a plurality of image partitions.

20. The computer readable medium of claim 16, further comprising sending the print job to a printer, wherein the printer receives the print job and interprets the print job to develop printable bitmap images of each of the plurality of image partitions on a sheet of the selected medium.
